(19) United States
(12) Patent Application Publication
(10) Pub. No.: US 2016/0202278 A1
(43) Pub. Date: Jul. 14, 2016

(54) AUTOMATIC METHOD AND AUTOMATED DEVICE FOR PROCESSING A PLURALITY OF CELL SUSPENSIONS

(71) Applicant: NOVACYT, Velizy Villacoublay (FR)

(72) Inventor: Eric PELTIER, Clamart (FR)

(21) Appl. No.: 14/911,010

(22) PCT Filed: Aug. 8, 2014
(86) PCT No.: PCT/EP2014/067123

§ 371 Date: Feb. 8, 2016

(30) Foreign Application Priority Data
Aug. 9, 2013 (FR) 13 57922

(51) Int. Cl. G01N 35/00; G01N 1/31; G01N 35/10; G01N 1/30

(52) U.S. Cl. CPC G01N 35/00029; G01N 1/30; G01N 1/312; G01N 35/10; G01N 2035/1053; G01N 2035/00138; G01N 2035/00495

(57) ABSTRACT

This method for processing a plurality of cell suspensions comprises at least the following steps:
(a) Loading a plurality of vials (4) onto a receiving plate (6), each vial (4) comprising a cell suspension to be analyzed;
(b) Loading a plurality of intermediate containers (20) into a receptacle (18);
(c) Extracting, by pipetting means (24), a sample from a cell suspension in a vial (4) and depositing this sample in an intermediate container (20); and
(e) taking a sample of a cell suspension in an intermediate container (20) and depositing this sample in an analysis container (32, 36); the steps (c) and (e) being repeated for each vial (4) to be analyzed.

The method further comprises, between the extraction step (c) and the sample-taking step (e), a step (d) for cell processing the extracted sample by cell processing means, the step (d) being repeated for each vial (4) to be treated.

The invention also relates to an automated device applying this method.

### FIELD OF THE INVENTION

The present invention relates to a method for processing a cell suspension, of the type comprising at least the following steps:
(a) loading a plurality of vials on a receiving plate, each vial comprising a cell suspension to be analyzed;
(b) loading a plurality of intermediate containers in a receptacle;
(c) extracting, by means of pipetting means, a sample from a cell suspension in a vial and depositing this sample in an intermediate container; and
(e) taking a sample from a cell suspension in an intermediate container and depositing this sample in an analysis container; steps (c) and (e) being repeated for each vial to be analyzed.

The invention also relates to an automated device for applying this method.

The field of the invention is that of systems for processing and analyzing a cell suspension, notably systems for processing and analyzing a set cytological spread. Cytological diagnostic covers diagnostic techniques based on morphological examination of the cells. It is very well adapted for cancer screening and detecting cancer and pre-cancer lesions, for example of the uterine cervix.

### BACKGROUND OF THE INVENTION

An automated device of the aforementioned type is for example described in document WO 2011/117523. Such an automated device gives the possibility of obtaining a perfectly legible cell deposit, representative of the area of interest, in a thin layer, this in order to improve the quality of the diagnostic.

In order to additionally improve the legibility of certain specific entities of the cells such as the nuclei, cytoplasms or other constitutive elements of the cell, it is sought to proceed with staining or with “marking” of these specific entities. For this purpose, automated devices which allow staining or marking of certain areas of interest of cells are known. In such automated devices, analysis slides on which the cells have been deposited with a view to their subsequent analysis are laid out in a support. The support is then moved by the automated device, and then immersed in several pans for successive staining and rinsing in order to ensure coloration of the cells.

However, such automated devices may cause crossed contamination between the analysis slides corresponding to different patients. Indeed, during the staining operations in the staining pans, certain cells of a given analysis slide may detach and again adhere onto a wall of a pan and/or on another analysis slide, as this is described for example in document “Cellular contamination during automatic and manual staining of cytological smears” of W. T. Barr, D. E. B. Powell and J. B. Raffan, published on Oct. 23, 1970 in “J Clin Pathol.—604-607”.

Automated devices giving the possibility of decoupling the staining or the marking of the cells of several analysis slides are also known, in order to process in a unitary way the cell spread on a given analysis slide. Such an automated device is for example described in document EP 0 590 506. The automated device comprises for each analysis slide, a cylindrical well giving the possibility of depositing the cells of a sample on a slide and of thereby isolating the cells of the slide from cells from other slides. Suction of the supernatant is then carried out within the well, and the cells are then stained or marked by a cell processing device.

However, because of the operation for suction of the supernatant, such an automated device does not always allow preparation of cell deposits in two dimensions, the suction causing a deposit in three dimensions, which is more difficult to digitize. Further, the processing device is a conventional device comprising at least one rinsing needle secured to staining or cell marking needles. Consequently, the processing device moves in close proximity to the cells to be treated and may cause cross contamination of the slides.

### SUMMARY OF THE INVENTION

One of the objects of the invention is to overcome these drawbacks by proposing a cell processing method allowing to reduce the risk of cross contamination between the analysis slides, while giving the possibility of obtaining, on each analysis slide, a perfectly legible and two dimensional deposit of cells.

For this purpose, the object of the invention is a method for processing at least one cell suspension of the aforementioned type, further including, between the extraction step (c) and the sample-taking step (e), a step (d) of cell processing of the extracted sample by means of cell processing means, step (d) being repeated for each vial to be treated.

By carrying out the cell processing step of the sample before the step of depositing this sample in an analysis container, a unitary processing of the sample is thus possible, and gives the possibility of subsequently avoiding any cross contamination between the slides.

According to other features of the method according to the invention:
the cell processing means comprise cell staining means and the cell processing step (d) is a cell staining step;
the cell processing means comprise means for marking a cell bio-marker and the cell processing step (d) is a step for marking a cell bio-marker;
the cell processing means comprise centrifugation means, and the cell processing step (d) for the extracted sample includes at least the following steps:
   (l) applying a processing fluid to the cell sample inside the intermediate container;
   (m) centrifuging the intermediate container;
   (n) removing a supernatant inside the intermediate container;
   (o) applying a rinsing fluid to the cell sample inside the intermediate container;
   (p) centrifuging the intermediate container;
   (q) removing a supernatant inside the intermediate container;
the step (l) of applying a processing fluid is carried out by injection, by the pipetting means, of the processing fluid into the cell sample inside the intermediate container, and the cell processing step (d) of the extracted sample further includes the following steps:
   (f) applying a rinsing fluid to the cell sample inside the intermediate container;
   (g) centrifuging the intermediate container;
   (h) removing a supernatant inside the intermediate container;
   the steps (f) to (h) taking place before the step (l) of applying a processing fluid;
the intermediate containers comprise units pre-filled with the processing fluid, and the step (l) of applying a processing fluid to the cell sample is carried out simultaneously with the step (c) of depositing this sample in the intermediate container;
each analysis container includes a decantation well and an analysis slide placed facing the decantation well, the decantation well being provided with a receiving chamber placed above the analysis slide, the receiving chamber having an open bottom arranged so as to exert pressure on a peripheral absorption sheet, and the method further includes at least the following successive steps:
   (r) loading analysis containers on the receiving plate;
   (s) producing a cell analysis spread on the analysis slide, the cell spread resulting from the deposition of the sample in the decantation well;
   the step (e) of taking a sample from a cell suspension taking place between step (r) of loading the analysis containers and the step (s) of producing a cell analysis spread on the analysis slide.

The object of the invention is also an automated device for processing at least one cell suspension comprising:
at least one vial containing the cell suspension to be analyzed;
at least one plate for receiving the vial;
at least one intermediate container;
at least one decantation well for the cell suspension;
pipetting means able to take the sample from the cell suspension in the vial and to pour this sample into the intermediate container, and capable of taking the sample of the cell suspension in the intermediate container and of pouring this sample into the decantation well;
wherein the automated device includes means for cell processing of the sample from the cell suspension, able to process the sample from the cell suspension before depositing this sample by the pipetting means in the decantation well.

According to other features of the automated device according to the invention:
the automated device includes at least one rinsing fluid container and the cell processing means comprise centrifugation means;
the automated device includes a movable arm on which are attached the pipetting means and the cell processing means include at least a processing fluid container, the movable arm being able to displace the pipetting means so as to pass above at least the receiving plate, the intermediate container, the decantation well and the processing container, the pipetting means being able to take the processing fluid in the container and to pour in an intermediate container the sampled processing fluid;
the automated device is laid out so as to apply the method as described earlier.

### BRIEF DESCRIPTION OF THE DRAWINGS

The invention will be better understood upon reading the description which follows, only given as an example and made with reference to the appended drawings, wherein:

FIG. 1 is a schematic sectional view of an automated processing device according to the invention;

FIG. 2 is a schematic perspective view of the automated device of FIG. 1 according to a first embodiment; and

FIG. 3 is a sectional view of a pre-filled unit intended to be received into the automated device of FIG. 1 according to a second embodiment.

### DETAILED DESCRIPTION OF CERTAIN EMBODIMENTS OF THE INVENTION

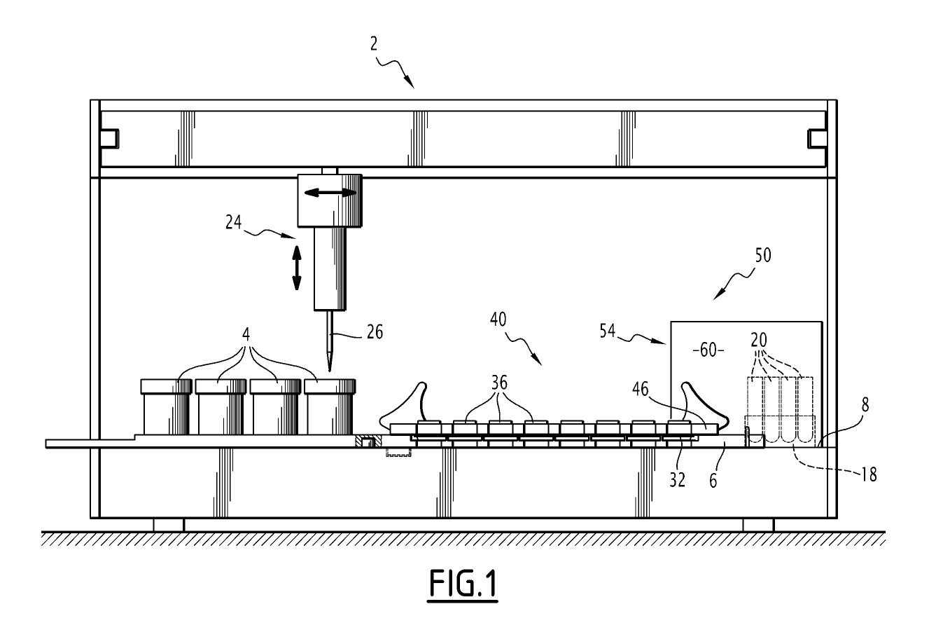

With reference to FIG. 1, an automated device 2 for processing a cell suspension according to a first embodiment of the invention is described. The automated processing device 2 comprises at least one vial 4 containing a cell suspension to be analyzed, such as for example a set cytological suspension.

Such a cytological suspension may for example stem from a screening operation by a smear test of the uterine cervix, or from any other cell sampling means intended for screening and/or diagnostic. This cytological suspension in particular comprises cells.

The cells are then immersed in a vial 4 containing a fixative and thereby form the cell suspension.

The fixative, or fixing solution, is intended to preserve and store cytological samples or takings, comprising cells, with view to their subsequent analysis by a cytologist. Therefore, the fixative should preserve the integrity of the cells, in particular their morphology, in the condition in which they were before their sampling.

The automated device 2 further comprises at least one receiving plate 6 bearing at least the vial 4 containing the cell suspension to be analyzed and a support 8 on which is positioned the receiving plate 6. Preferably, this vial 4 has the same characteristics as those described in document EP-2 111 300, so as to be able to attach the vial 4 on the receiving plate 6, and certain characteristics described in document WO-2006/058989 in order to be able to prepare and analyze the cell suspension.

Further, the automated device 2 includes at least one receptacle 18 bearing at least one intermediate container 20. Preferably, the automated device 2 includes as many receptacles 18 as there are receiving plates 6, each receptacle 18 bearing a number of intermediate containers 20 at least equal to the number of vials 4 borne by each receiving plate 6.

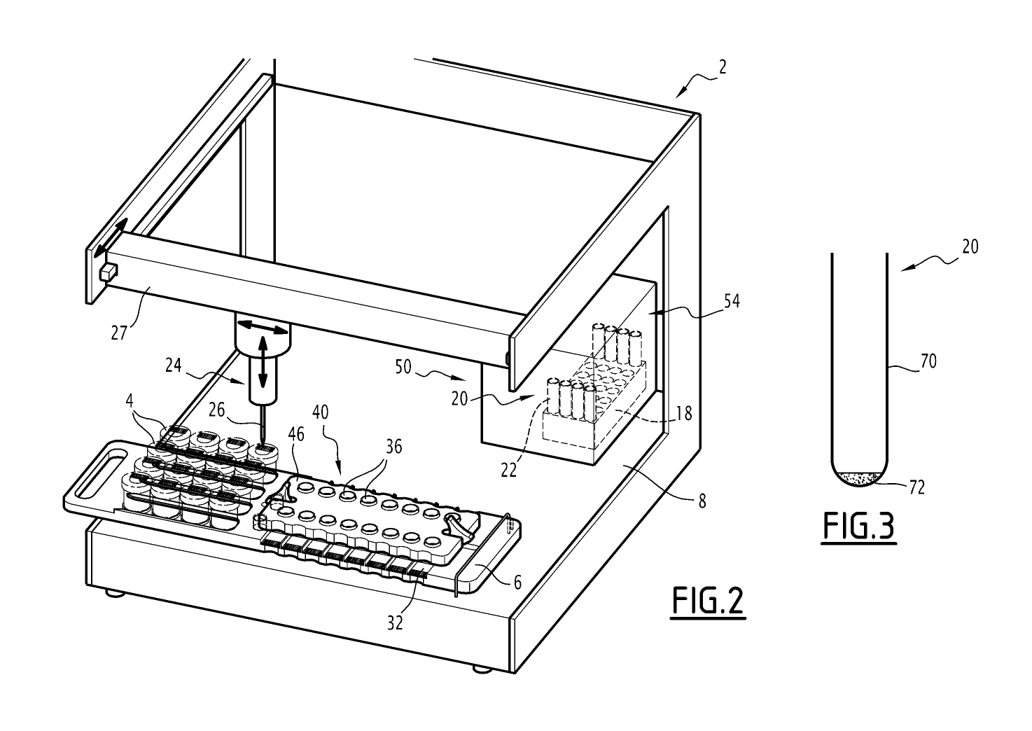

In the exemplary embodiment of FIG. 2, the intermediate containers 20 of the automated device 2 include micro-wells 22. In an alternative not shown, the intermediate containers 20 of the automated device 2 may include centrifugation cones separate from each other or bound together.

The automated device 2 further includes pipetting-distribution means 24, called pipetting or sampling means subsequently, i.e. giving the possibility of taking and/or pouring/filling a sample of the cell suspension. These pipetting means 24 extend above the receiving plate 6. The sample is a specific volume portion of the cell suspension containing elements of interest to be analyzed, for example cells.

These pipetting means 24 are movable so as to pass above each vial 4 in order to carry out sampling and/or filling as illustrated by the arrows of FIG. 1. The pipetting means 24 are further movable so as to pass above each intermediate container 20. The pipetting means 24 are therefore able to pour into an intermediate container 20 a sample of the cell suspension taken in a vial 4 and of taking a sample from a cell suspension contained in an intermediate container 20, as this will be described subsequently.

Moreover, the automated device 2 comprises at least one container containing rinsing fluid, the container not being illustrated in the figures for the sake of clarity. The pipetting means 24 are movable so as to pass above said or each rinsing container, to sample rinsing fluid in this container and to pour into an intermediate container 20 the sampled rinsing fluid.

The pipetting means 24 are formed with at least one pipette 26 or needle, and preferably with a plurality of pipettes, laid out in parallel so as to be able to simultaneously take samples in a plurality of vials 4 and to prepare them simultaneously with view to their analysis. In an alternative not shown, the pipetting means 24 are formed with at least one disposable pipetting end piece, and preferably a plurality of disposable end pieces.

The pipetting means 24 are attached on a movable automated arm 27 on the automated device 2 above the plate 6 and the receptacle 18.

Further, the automated device 2 comprises at least one analysis container intended for receiving/containing the sample of the cell suspension, sampled in an intermediate container 20 and poured into or above the analysis container by the pipetting means 24.

For example, the analysis containers may include spreader slides 32, or further analysis or decantation wells 36 depending on the analysis method selected by the practitioner.

The analysis containers 32, 36 are specifically and fixedly maintained on the automated device 2.

According to an alternative not shown, the analysis containers include at least one sampling or aliquoting tube and a support into which several tubes may be inserted in order to maintain them in a fixed position.

Complementarily, as illustrated in FIGS. 1 and 2, the automated device 2 includes a device 40 for depositing cells by decantation onto an analysis slide. Such a device 40 for depositing cells by decantation onto an analysis plate has already been described in document WO 2009/000999 and one skilled in the art may refer to this document.

This device 40 includes at least one decantation well 36 placed above an analysis slide 32, and an absorbent material.

The suspension is poured, by the pipetting means 24, into a receiving chamber of the decantation well 36 placed above the analysis slide 32, and the bottom of which is open and extends facing a deposit area of cells of the analysis slide 32. The bottom of the chamber is in fluidic communication with the absorbent material of the preservation or fixative liquid in order to gradually absorb the latter and to allow a homogenous deposit by decantation of the cells on the deposition area of cells of the analysis slide 32. A uniform cell deposit is thus obtained in a reduced decantation time.

The absorbent material is partly compressed by a decantation press 46 between the bottom of the receiving chamber and the analysis plate around the cell deposition area.

Further, the automated device 2 includes means 50 for cell processing of the cell suspension intended to process a sample of the cell suspension contained in the intermediate container 20.

In the exemplary embodiment of FIGS. 1 and 2, the cell processing means 50 include centrifugation means 54.

The centrifugation means 54 are for example formed with a centrifuge 60, as illustrated in FIGS. 1 and 2. In the exemplary embodiment of FIGS. 1 and 2, the receptacles 18 bearing the intermediate containers 20 are laid out inside the centrifuge 60. The centrifuge 60 is adapted for carrying out centrifugation of the cell suspension of each intermediate container 20, with view to separation of the cell suspension into several phases.

According to the embodiment illustrated in FIG. 2, the cell processing means 50 further include at least one container containing a processing fluid, the container not being illustrated in the figures for the sake of clarity. In the exemplary embodiment of FIG. 2, the processing fluid is a solution generally used for cell stainings such as stainings of nuclei, cytoplasms or other constitutive elements of the cell. The solution comprises at least one cell coloring agent. Alternatively, the processing fluid is a solution used for markings of cell biomarkers. By cell biomarker is meant any specific entity of a cell such as a nucleus, a cytoplasm or any other constitutive element of the cell. In this case, the solution comprises at least one cell marker.

In the embodiment illustrated in FIG. 2, the pipetting-distributing means 24 are movable so as to pass above said or each processing container, to sample the processing fluid in this container and to pour into an intermediate container 20 the sampled processing fluid.

The method for processing these suspensions applied by the automated device 2 described earlier will now be detailed, in the case of the preparation of analysis slides 32.

First, after having taken the cell samples to be treated, the practitioner transfers the cell samples into vials 4.

Next, the technician or the user, after a sufficient time for fixing the cells, for example a fixing time of at least 30 minutes, loads the vials 4 of cell suspensions onto the receiving plate 6 as well as at least as many analysis containers, preferably analysis slides 32.

Next, he/she positions the absorbent sheet on the plate 6 so that each analysis slide 32 is positioned between the receiving plate 6 and the absorption sheet. A plurality of decantation wells 36 are loaded in a press 46. The decantation press 46 is installed above the plate 6 so that each decantation well 36 is positioned above an analysis slide 32, as described in document WO 2009/000999.

The plates 6 are then loaded into the automated device 2.

In parallel or subsequently to this step of loading the plates 6 into the automated device 2, the technician or user inserts, into each receptacle 18, at least as many intermediate containers 20 as there are vials 4 borne by each receiving plate 6. The receptacles 18 are then loaded into the centrifuge 60 of the automated device 2.

The pipetting means 24 are displaced above the vial 4 containing the cell solution to be treated. The needle or pipette 26 of the pipetting means 24 then performs a taking of a sample of a cell suspension within the vial 4.

The pipetting means 24 are then displaced above an intermediate container 20 in order to pour/deposit the sample into the intermediate container 20, in other words into the micro-well 22 in the exemplary embodiment of FIG. 2.

A cell processing operation of a sample from a cell suspension contained in an intermediate container 20 is then performed by the cell processing means 50. In the exemplary embodiment of FIG. 2, the cell processing operation is cell coloration of a cell suspension contained in an intermediate container 20. Alternatively, the cell processing operation is a marking of cell bio-markers of a cell suspension contained in an intermediate container 20.

Preferably, this cell processing step of a sample from a cell suspension is itself accomplished in eleven sub-steps, for which some of them are optional.

During a first sub-step, the pipetting means 24 are displaced above the rinsing container, so as to sample the rinsing fluid in the container. The pipetting means 24 are then displaced above the intermediate container 20 containing the cell suspension sample.

During a second sub-step, the pipetting means 24 pour the rinsing fluid into the intermediate container 20 positioned inside the centrifuge 60 in the exemplary embodiment of FIGS. 1 and 2.

During a third sub-step, the centrifugation means 54 achieve centrifugation of the cell suspension contained in the intermediate container 20 in order to separate this cell suspension into several phases.

During a fourth sub-step, the pipetting means 24 are displaced above the intermediate container 20. The pipetting means 24 then sample a volume of the cell solution, a so-called “supernatant” volume. This “supernatant” volume is then poured into a container not shown. Alternative, this “supernatant” volume is extracted by tilting the intermediate container 20, for example with a tilt according to an angle of the order of 90 degrees, this tilt allowing the “supernatant” volume to be poured into a container not shown. This step has the purpose of washing and of preserving the selected cell suspension in the intermediate container 20, with a view to its processing.

According to a fifth sub-step, a processing fluid is applied to the cell suspension sample contained in the intermediate container 20. More specifically, according to the first embodiment of the invention, the pipetting-distributing means 24 are displaced above the processing containers, so as to sample some processing fluid in a processing container. The pipetting-distributing means 24 are then displaced above the intermediate container 20 and pour the processing fluid into the intermediate container 20. In the exemplary embodiment of FIG. 2, at least one pipette 26 of the pipetting means 24 samples the processing solution comprising at least one coloring agent or cell marker and pours this processing solution into the intermediate container 20.

During a sixth sub-step, the centrifugation means 54 achieve centrifugation of the cell suspension contained in the intermediate container 20 in order to separate this cell suspension into several phases.

During a seventh sub-step, the pipetting means 24 are displaced above the intermediate container 20. The pipetting means 24 then sample a “supernatant” volume of the cell solution. This “supernatant” volume is then poured into a container not shown. Alternatively, this “supernatant” volume is extracted by tilting the intermediate container 20, for example with a tilt according to an angle of the order of 90°, this tilt allowing the “supernatant” volume to be poured into a container not shown.

During an eighth sub-step, the pipetting means 24 are displaced above the rinsing container, so as to sample the rinsing fluid in the container. The pipetting means 24 are then displaced above the intermediate container 20 containing the colored or marked cell suspension sample.

During a ninth sub-step, the pipetting means 24 pour the rinsing fluid into the intermediate container 20.

During a tenth sub-step, the centrifugation means 54 achieve centrifugation of the cell suspension contained in the intermediate container 20 in order to separate this cell suspension into several phases.

During an eleventh sub-step, the pipetting means 24 are displaced above the intermediate container 20. The pipetting means 24 then sample a “supernatant” volume of the cell solution, and then pour this “supernatant” volume into a container not shown.

Alternatively, the cell processing step for a sample from a cell suspension does not comprise the second, fourth, tenth and/or eleventh sub-steps.

A taking of a sample of a cell suspension processed in an intermediate container 20 is then achieved by the pipetting-distributing means 24. More specifically, the pipetting-distributing means 24 are displaced above the intermediate container 20 containing the cell solution to be analyzed. The needle or pipette 26 of the pipetting means 24 then achieves a taking of a sample of a cell suspension within the intermediate container 20. In an alternative not shown, before achieving the taking of a sample of a cell suspension in an intermediate container 20, the pipetting-distributing means 24 first sample a volume of a cell adhesive contained in a container positioned for this purpose in the automated device 2.

The pipetting means 24 are then displaced above a decantation well 36 in order to pour/deposit the sample in the decantation chamber and to produce an analysis slide 32 comprising a cell spread to be analyzed. The cell spreading results from the depositing of the sample in the decantation well as described in document WO 2009/000999 and to which one skilled in the art may refer.

A decantation takes place on the slide 32 for a period for example substantially comprised between 5 and 60 minutes, and preferably equal to 15 minutes for preparing an analysis slide.

The steps for taking and for processing the sample, and for producing the slide are repeated for each vial 4 to be analyzed.

By the cell processing means 50, the automated device according to the first embodiment of the invention notably gives the possibility of carrying out monochromatic or polychromatic cell staining processing operations.

The automated device according to the invention further allows automated production and processing of smear tests and other cytological thin layer samplings.

The method for processing cell suspensions applied by the automated device 2 gives the possibility of processing each cell suspension sample in a unitary way, in a hermetic container, thus ensuring the isolation of the sample with respect to the outer environment. This gives the possibility of preserving the integrity of all the solutions and cytological samples by avoiding cross contamination risks, notably crossed contamination between the analysis slides.

Further, unlike the processing method as the one described in document EP 0 590506, no suction and/or staining operation is carried out on the analysis slide once the cell suspension sample has been deposited on the slide. This gives the possibility of obtaining a cell spread which is legible in two dimensions, thereby ensuring preservation of the selected elements, as well as achieving complete and satisfactory digitization of the cell spread.

It is thus conceivable that the cell processing method according to the invention allows optimization of the cell processing operation which is ensured in suspension and no longer by spreading, but also reduction in the crossed contamination risks between the analysis slides, while giving the possibility of obtaining, on each analysis slide, a deposit of cells perfectly legible in two dimensions in order to optimize the step for digitizing the processed spreader slide.

Further, it allows standardization, within a single automated device, of the various steps for preparing the samples, for cell processing of these samples and for preparing analysis slides. This gives the possibility of gaining room and therefore a reduction in the costs as compared with traditional processing techniques.

FIGS. 1 and 3 illustrate a second embodiment of the invention for which the elements similar to those of the first embodiment, described earlier, are marked with identical references, and will therefore not be again described.

Unlike the first embodiment, the cell processing means 50 no longer include containers containing a processing fluid. Further, the intermediate containers 20 no longer include any micro-wells 22, but include units 70. Each unit 70 is pre-filled with a processing fluid 72, as illustrated in FIG. 3. In the exemplary embodiment of FIG. 3, the processing fluid 72 is a solution comprising at least one coloring agent or cell marker.

The method for processing cell suspensions applied by the automated device 2 according to the second embodiment is similar to that of the first embodiment described earlier.

In particular, during the step for loading the intermediate containers 20 into each receptacle 18, the technician or user inserts, into the receptacle 18, the pre-filled units 70.

However, unlike the processing method according to the preferential example of the first embodiment, the step of applying a processing fluid to the cell suspension sample is carried out simultaneously with the depositing step of this sample, by the pipetting means 24, in the pre-filled unit 70. Indeed, during the deposit of the cell suspension sample in the pre-filled unit 70, the cell suspension mixes with the processing fluid 72 contained at the bottom of the unit 70, and the processing operation is applied to the cells of interest contained in the cell suspension sample.

The remainder of the processing method according to this second embodiment is similar to that of the first embodiment, and is therefore no longer described in detail.

Compared with the automated device according to the first embodiment, the automated device according to the second embodiment advantageously gives the possibility of performing less handling and optimizing the traceability of the processing solution used.

The other advantages of this second embodiment of the automated processing device are identical with those of the first embodiment, and will therefore not be again described.

1. A method for processing a plurality of cell suspensions comprising at least the following steps:
(a) loading a plurality of vials on a receiving plate, each vial comprising a cell suspension to be analyzed;
(b) loading a plurality of intermediate containers into a receptacle;
(c) extracting, by a pipettor, a sample of a cell suspension in a vial and depositing this sample in an intermediate container; and
(e) taking a sample of a cell suspension in the intermediate container and depositing this sample in an analysis container; the steps (c) and (e) being repeated for each vial to be analyzed;
wherein the method further comprises, between extraction step (c) and sample-taking step (e), a step (d) of cell processing of the extracted sample by a cell processor, step (d) being repeated for each vial to be treated, wherein the cell processing step (d) comprises a step (l) of applying a processing fluid to the cell sample inside the intermediate container.

2. The method according to claim 1, wherein the cell processor comprises cell stain and wherein the cell processing step (d) is a cell staining step.

3. The method according to claim 1, wherein the cell processor comprise a marker for marking a cell biomarker and wherein step (d) is a step for marking a cell biomarker.

4. The method according to claim 1, wherein the cell processor comprises a centrifuge, and wherein step (d) comprises at least the following steps:
(m) centrifuging the intermediate container;
(n) removing a supernatant inside the intermediate container;
(o) applying a rinsing fluid to the cell sample inside the intermediate container;
(p) centrifuging the intermediate container; and
(q) removing a supernatant inside the intermediate container.

5. The method according to claim 4, wherein step (l) of applying a processing fluid is carried out by injection, by the pipettor, of the processing fluid into the cell sample inside the intermediate container, and wherein step (d) further comprises the following steps:
(f) applying a rinsing fluid to the cell sample inside the intermediate container;
(g) centrifuging the intermediate container; and
(h) removing a supernatant inside the intermediate container;
the steps (f) to (h) taking place before the step (l) of applying a processing fluid.

6. The method according to claim 4, wherein the intermediate containers comprise units pre-filled with the processing fluid, and wherein step (l) of applying a processing fluid to a cell sample is carried out simultaneously with step (c) of depositing this sample in the intermediate container.

7. The method according to claim 1, wherein each analysis container comprises a decantation well and an analysis slide placed facing the decantation well, the decantation well being provided with a receiving chamber placed above the analysis slide, the receiving chamber having an open bottom laid out so as to exert pressure on a peripheral absorption sheet, and wherein the method further includes at least the following successive steps:
(r) loading the analysis containers onto the receiving plate; and
(s) producing a cell analysis spread over the analysis slide, the cell analysis spread resulting from the depositing of the sample in the decantation well;
the step (e) of taking a sample of a cell suspension taking place between step (r) of loading the analysis containers and step (s) of producing a cell analysis spread over the analysis slide.

8. An automated device for processing at least one cell suspension, comprising:
at least one vial containing the cell suspension to be analyzed;
at least one receiving plate for the vial;
at least one intermediate container;
at least one well for decantation of the cell suspension;
a pipettor that is capable of taking the sample of the cell suspension into the vial, pouring the sample into the intermediate container, taking the sample of the cell suspension into the intermediate container and pouring the sample into the decantation well;
wherein the automated device comprises a cell processor configured to process the sample of the cell suspension before depositing the sample by the pipettor in the decantation well.

9. The automated device according to claim 8, comprising at least one rinsing fluid container and wherein the cell processor comprises a centrifuge.

10. The automated device according to claim 8, comprising a movable arm on which are attached the pipettor and wherein the cell processor comprises at least one processing fluid container, the movable arm being able to displace the pipettor so as to pass above at least the receiving plate, the intermediate container, the decantation well and the processing container, the pipettor being able to sample the processing fluid in the container and to pour into an intermediate container the sampled processing fluid.

11. The automated device according to claim 8, wherein it is laid out for processing a plurality of cell suspensions comprising at least the following steps:
(a) loading a plurality of vials on a receiving plate, each vial comprising a cell suspension to be analyzed;
(b) loading a plurality of intermediate containers into a receptacle;
(c) extracting, by the pipettor, a sample of a cell suspension in a vial and depositing this sample in an intermediate container; and
(e) taking a sample of a cell suspension in an intermediate container and depositing this sample in an analysis container; the steps (c) and (e) being repeated for each vial to be analyzed;
wherein the method further comprises, between extraction step (c) and sample-taking step (e), a step (d) of cell processing of the extracted sample by a cell processor, step (d) being repeated for each vial to be treated, the cell processing step (d) including a step (l) of applying a processing fluid to the cell sample inside the intermediate container.
